(19) United States
(12) Patent Application Publication
(10) Pub. No.: US 2007/0083330 A1
(43) Pub. Date: Apr. 12, 2007

(54) Fast method for reconstruction of 3D formation rock properties using modeling and inversion of well-logging data

(75) Inventor: Michael A. Frenkel, Barker, TX (US)

Correspondence Address: MADAN, MOSSMAN & SRIRAM, P.C., 2603 AUGUSTA, SUITE 700, HOUSTON, TX, 77057, US

(73) Assignee: Baker Hughes Incorporated, Houston, TX (US)

(21) Appl. No.: 11/540,372

(22) Filed: Sep. 29, 2006

Related U.S. Application Data
(60) Provisional application No. 60/723,991, filed on Oct. 6, 2005.
(60) Provisional application No. 60/785,423, filed on Mar. 24, 2006.

(51) Int. Cl. G01V 3/18

(52) U.S. Cl. 702/7

(57) ABSTRACT

A method and apparatus for interpretation of well log data. An inversion of the data is carried out using a sequence of short window inversions.

### CROSS-REFERENCES TO RELATED APPLICATIONS

This application claims priority from U.S. Provisional Patent Application Ser. No. 60/723,991 filed on 6 Oct. 2005 and U.S. Provisional Patent Application Ser. No. 60/785,423 filed on 24 Mar. 2006.

### BACKGROUND OF THE INVENTION

1. Field of the Invention

The invention is related generally to the field of interpretation of measurements made by well logging instruments for the purpose of determining the properties of earth formations.

2. Background of the Art

A variety of instruments are used for evaluating the properties of formations surrounding a borehole in an earth formation. These include electromagnetic induction, electromagnetic wave propagation, galvanic, nuclear and acoustic logging tools. These logging tools give measurements of properties such as apparent resistivity (or conductivity) of the formation that when properly interpreted are diagnostic of the petrophysical properties of the formation and the fluids therein. A common objective of the evaluation of measurements made by the tools is to obtain formation properties with a higher resolution than the typical aperture (length) of the tools. In addition, for some of these tools, the measurements are responsive to formation properties outside the aperture of the tools. This invention is discussed in the context of a specific instrument for measuring formation conductivity (or, equivalently, formation resistivity). It is to be understood that the methodology discussed herein is applicable to other resistivity instruments as well as instruments which measure other formation properties.

The physical principles of electromagnetic induction resistivity well logging are described, for example, in, H. G. Doll, Introduction to Induction Logging and Application to Logging of Wells Drilled with Oil Based Mud, Journal of Petroleum Technology, vol. 1, p. 148, Society of Petroleum Engineers, Richardson Tex. (1949). Many improvements and modifications to electromagnetic induction resistivity instruments have been devised since publication of the Doll reference, supra. Examples of such modifications and improvements can be found, for example, in U.S. Pat. No. 4,837,517; U.S. Pat. No. 5,157,605 issued to Chandler et al, and U.S. Pat. No. 5,452,761 issued to Beard et al. Other tools include the HDLL (High Definition Lateral Log) of Baker Hughes Incorporated, described in U.S. Pat. No. 6,060,885 to Tabarovsky et al., and any generic Array Laterolog tools, e.g., the High-Resolution Laterolog Array tool (HRLA) of Schlumberger Inc.

Analysis of measurements made by any array induction logging tool, for example such as that disclosed by Beard and galvanic logging tools such as the HDLL and HRLA or any generic Array Laterolog tools, is based on inversion.

One problem with inversion is that the earth is characterized by a 2-D model (layers with radial changes in resistivity within each layer) or a 3-D model (layers with radial changes in resistivity within each layer, and a relative dip between layers and the borehole). A rigorous 2-D or 3-D inversion techniques would be quite time consuming and impractical for wellsite implementation. See, for example, Mezzatesta et al., and Barber et al. Several methods have been used in the past for speeding up the inversion. Frenkel et al. (SEG Extended Abstracts, 1995; SPE #36505, 1996, SPE #77793) and in U.S. Pat. No. 5,889,729 to Frenkel et al., having the same assignee as the present invention and the contents of which are fully incorporated herein by reference disclose a so-called rapid well-site inversion method suitable for well-site (not a real-time) processing of array resistivity data. A rapid inversion method allows for substantially reducing the computational time by subdividing the 2-D/3-D problem into a sequence of smaller 1-D problems. For example, each iteration of the rapid 2-D inversion consists of the following steps: 1) calculation of all 2-D responses associated with the current earth structure, 2) for each layer, calculation of responses, assuming the layer is infinitely thick, 3) estimation of shoulder-bed corrections as the difference in responses from the two previous steps, 4) correction of the logging data for shoulder-bed effects, and 5) using the shoulder-bed corrected data, execution of a 1-D inversion problem at each layer. Each iteration consisting of all previous steps provides an updated 2-D distribution of formation parameters. The iterative cycle is repeated until the misfit between synthetic and actual data becomes less than some predetermined small value. Moreover, the rapid inversion method can be further accelerated via application of pre-calculated Look-Up Tables (LUT) of 1-D forward responses of cylindrical models. This approach is described in SPE #36505, 1996, SPE #77793, and in U.S. Pat. No. 5,889,729 to Frenkel et al. Griffiths et al. (SPWLA 1999, paper DDD) disclose a so-called 1-D+1-D method processing of HRLA logs. The processing consists of the following steps: borehole correction, 1-D inversion of individual logs in z direction (shoulder-bed-correction), and 1-D radial inversion of the corrected logs. The main shortcomings of this method are it does not satisfy a real-time processing requirements and it may provide inaccurate results in thin invaded layers due to coupling between shoulder beds and invasion in the adjacent layers. So it may lead to significant errors in thin invaded layers. To check the quality and correct inversion results, Griffiths et al. suggest to run a rigorous 2-D inversion which makes this technique is not applicable to even post-acquisition well-site processing.

Prior art methods for real-time well-site interpretation typically perform the 1-D radial inversion on a point by point basis. Shoulder bed effects and borehole deviation effects are not considered. Correction is made only for the borehole and invasion effects and could be approximate and lead to incorrect 1-D inversion results even in relatively thick (˜5 ft or 1.5 m) invaded formations. In addition, the inversion process may become unstable at layer boundaries, so that significant post inversion processing is often required. This filtering results in a curve of Rₜ (true formation or virgin zone resistivity) that frequently looks little different from the deep-reading logs of focused curves and produces little additional information. There is a need for a method of inversion of array resistivity measurements that does not suffer from these drawbacks. The present invention addresses this need.

### SUMMARY OF THE INVENTION

One embodiment of the invention is a method of processing well log data acquired in a layered medium. The method performs a layer-by-layer reconstruction of formation properties. At each step, the method runs a short-window inversion or a short-window look-up table (LUT). The method accumulates results after execution of each window. The processing can start from the top or from the bottom. A cross-check can be made of results obtained by processing in different directions. The method can be used for vertical, deviated and/or horizontal wells for Logging-While-Drilling (LWD) or wireline applications. The log measurements may be galvanic or induction resistivity measurements, multicomponent induction measurements, nuclear measurements or acoustic measurements. Shoulder bed effects may be considered in the processing. As part of the evaluation of the earth formation, parameters of interest such as a thickness of a layer in the earth formation, a resistivity of a layer, a resistivity of an invaded zone, a length of an invaded zone and/or a relative dip angle may be determined.

Another embodiment of the invention is an apparatus for acquiring and processing well log data acquired in a layered medium. The apparatus includes a processor which performs a layer-by-layer reconstruction of formation properties. At each step, the processor runs a short-window inversion or a short-window table look-up. The processor accumulates results after execution of each window. The processing can start from the top or from the bottom observation points. The processor can perform a cross-check of results obtained by processing in different directions. The apparatus can be used for vertical, deviated and/or horizontal wells for Logging-While-Drilling (LWD) or wireline applications. The log measurements may be galvanic or induction resistivity measurements, multicomponent induction measurements, nuclear measurements or acoustic measurements. The processor may consider shoulder bed effect in the processing.

Another embodiment of the invention is a machine readable medium for use with an apparatus that acquires well log data in a layered medium. The medium includes instructions which enable a processor to perform a layer-by-layer reconstruction of formation properties. The instructions include running a short-window inversion or a short-window look-up table (LUT). The machine readable medium may include ROMs, EPROMs, EEPROMs, Flash Memories and Optical disks.

### BRIEF DESCRIPTION OF THE FIGURES

The present invention is best understood with reference to the accompanying figures in which like numerals refer to like elements and in which:

FIG. 1 (Prior art) is a diagram illustrating a wireline logging tool in a borehole;

FIG. 2 (Prior art) shows an exemplary generic multi-laterolog array tool suitable for use with the present invention;

FIG. 3 is a flow chart of an embodiment of the invention in which a sliding inversion window is used;

FIG. 4 is a flow chart of an embodiment of the invention similar to that in FIG. 3 but with inversion starting at the bottom;

FIG. 5 is a flow chart of an embodiment of the invention that is a fast implementation of the method of FIG. 3; and

FIG. 6 is a flow chart of an alternate embodiment of the invention that is a fast implementation of the method of FIG. 3.

### DETAILED DESCRIPTION OF THE INVENTION

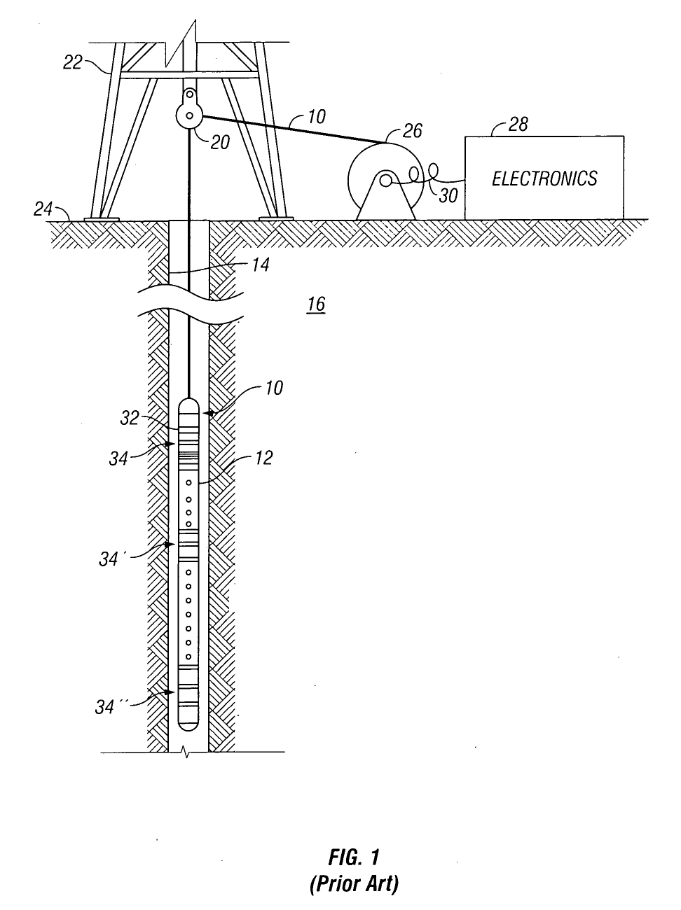

Referring now to FIG. 1, an exemplary prior art differential array resistivity instrument 10 will be described. Such an instrument has been described in U.S. Pat. No. 6,060,885 to Tabarovsky et al. having the same assignees as the present invention and the contents of which are incorporated herein by reference. The instrument 10 is shown disposed in a borehole 14 penetrating an earth formation 16 and supported by a wire cable 18. The cable 18 is supported and guided by a sheave wheel 20 suspended from a well structure 22 in place on the earth's surface 24 over the wellbore 14. The cable 18 is stored on a cable drum 26 which is controlled at the surface to lower and raise the differential array instrument 12 within the wellbore 14 at a predetermined logging speed. Commands for controlling the operation of the instrument 12 and the data collected by the instrument are transmitted electrically through the cable 18 and via interconnecting cable 30 to an electronics package 28 located at the surface. Alternatively, a downhole processor (not shown) may be used for doing some or all of the processing downhole.

The instrument 10 has an elongated mandrel or body 12, a single source electrode 32 located near the upper end of the instrument housing, and several groups of identical measuring electrodes 34, 34′ and 34″ uniformly distributed along the axis of the tool mandrel, which allow for performing a number of measurements at each logging depth.

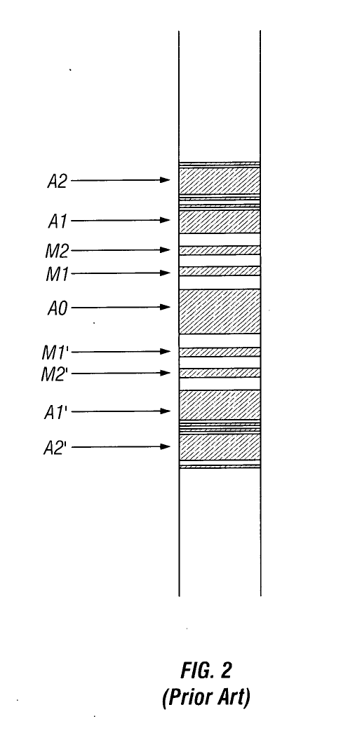

The present invention is suitable for processing of data from any array resistivity tool that has as its output apparent resistivity values with different depths of investigation. This includes multi-array induction tools such as the HDIL tool of Baker Hughes Incorporated, and Multi-Laterolog devices, such as those a laterolog array device. An exemplary laterolog device is shown in FIG. 2. The basic configuration consists of a central electrode A0 emitting a survey current with multiple guard electrodes above and below it The electrodes A0, A1, A2, along with their symmetric counterparts A0′, A1′, A2′, serve to emit current into the formation, while monitoring electrodes M1, M2 along with M1′, M2′ are used to measure potentials. Focusing current is sent between different guard electrodes to achieve greater or less focusing. The greater the focusing, the greater will be the depth of investigation. As discussed in Smits, three basic measurements are obtained in this way. This hardware focusing is further improved by software focusing, in which the signals from the basic measurements are superimposed mathematically to ensure proper focusing in a wide range of conditions.

Real-time estimation of formation parameters (e.g., Lₓₒ, Rₓₒ, and Rₜ) is normally carried out at a well-site using 1-D radial inversion of the borehole corrected array data with application of a neural networks (NN) or look-up tables (LUT) of the tool responses. See, for example, Smits et al. (SPE49328, 1998) and Zhang et al. (SEG Extended Abstracts 2000). Since this process is performed on a point-by-point basis, it does not take into account the shoulder bed effect, but corrects the data only for the invasion effect; it could lead to a significant difference between interpretation results and the true formation resistivity in thin invaded formations.

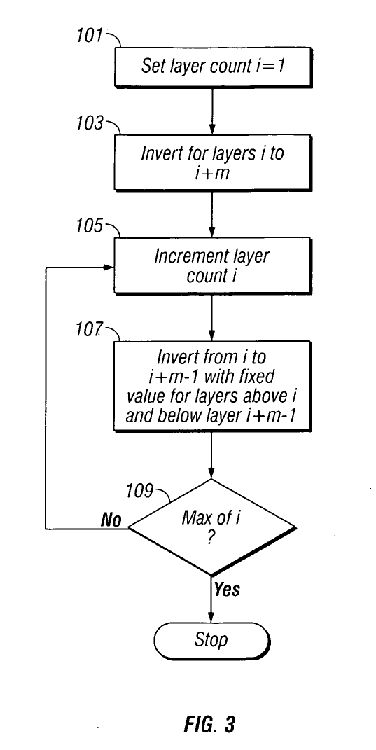

FIG. 3 shows is a flow chart of one embodiment of the present invention. The method starts 101 at the top layer, denoted by i=1. The layer boundaries may be defined, for example, by using a microresistivity imager. Alternatively, layers of fixed thickness may be defined. Measurements made by the logging tool over a number m of layers (i.e., from layer 1 to layer m) are inverted 103 using any suitable inversion technique. This includes the use of radial look-up tables, or the use of Neural Nets (NN). A special case uses three layer inversion (m=3), though any value of m greater than equal to 2 may be used. The initial layer is incremented by one (to 2) 105 and inversion is again carried out over layers i to i+m−1 107 keeping the values of the formation properties in layers 1, 2 . . . i−1 fixed at the previously determined values. It is also possible to include in the model several layers below layer i+m−1, but not invert for their parameters. The parameters of layers below layer i+m−1 can be estimated by real-time 1D LUT- or NN-based inversion. A check is made to see if the maximum number of layers (or the bottom layer) has been reached 109. If so, the process stops. If not, the layer count is again incremented and the process starts again at 105. The processing starting from the first layer may be referred to as a downward run.

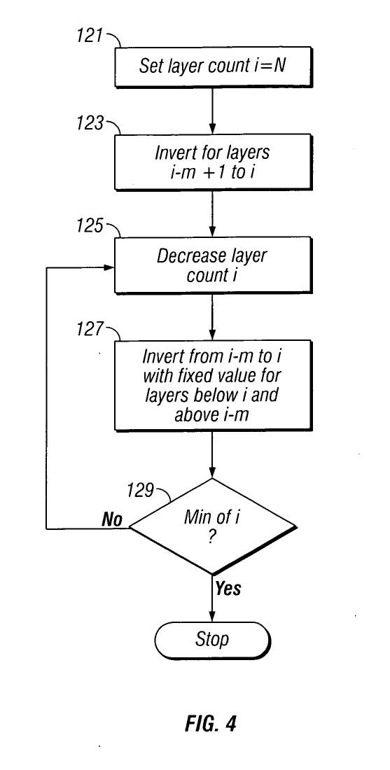

The method illustrated in FIG. 3 may also be carried out starting at the bottom layer. This is illustrated by the flow chart of FIG. 4 in which processing starts with the bottom layer N designated by 121. Measurements are inverted over a window from layer N−m+1 to layer N 123 using any suitable inversion technique. The layer index i is decreased by 1 (to N−1) 125 and inversion is carried out 127 for layers i−m+1 to layer i keeping the values below layer i fixed at the previously determined values. It is also possible to include in the model several layers above layer i-m, but not invert for their parameters. The parameters of layers above layer i-m can be estimated by real-time 1D LUT- or NN-based inversion. A check is made to see if the layer count has reached the minimum for processing (or inversion process has reached the top layer) 129. If so, the inversion is terminated. If not, the layer count is decreased again by one and processing is resumed at 125. The processing starting at the bottom layer may be referred to as an “upward run.”

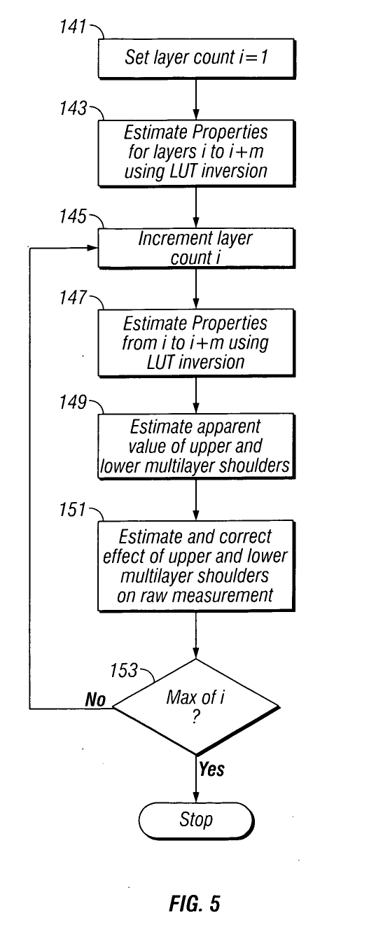

Another embodiment of the invention using a downward run is illustrated in FIG. 5. This method, like that in FIG. 3, starts with the layer count i set equal to 1 141. Properties for layers i to i+m−1 are then determined using a look-up table (LUT). This step is denoted by 143 and is computationally faster than the inversion 103 in FIG. 3. The layer count i is incremented by 1 145 and properties for layers i to i+m−1 are again determined 147 using a LUT. An apparent shoulder resistivity characterizing the layers above layer I is estimated via LUT-based modeling 149 and the raw measurements are corrected for the effect of this apparent shoulder resistivity 151. It is also possible to include in the model several layers below layer i+m−1. The parameters of these layers can be estimated by real-time 1D LUT or by NN-based inversion. A check is made to see if the layer count has reached a present maximum. If so, the processing is stopped. If not, the layer count is incremented by 1 and processing goes back to 145. Those versed in the art would recognize that an upward run using the basic methodology of FIG. 5 is possible. Such a variation is part of the invention and is not discussed herein. As before, a common implementation of the invention of FIG. 3 for both the upward and downward run uses m=3.

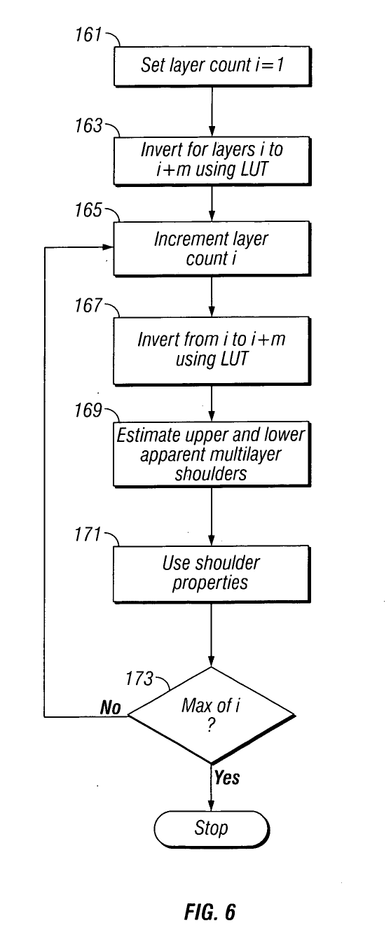

A variation of the downward run of FIG. 5 is illustrated in FIG. 6. The steps are the same as in FIG. 5. The difference is that 151 in FIG. 5 estimates and corrects the effect of the shoulder on the raw measurement whereas 171 in FIG. 7 uses the determined shoulder properties for further processing. An upward run is also possible and is not illustrated or discussed here.

In another embodiment of the invention, steps 149 and 151 of FIG. 5 are omitted. The omission of the shoulder effects is particularly useful in evaluating measurements made by logging tools where the shoulder bed effects are small or non-existent. The term “shoulder bed effect” refers to effect of adjacent beds on a log reading. For example, high-resistivity beds adjacent to a low-resistivity bed may result in more current flowing in the low-resistivity bed than if the high-resistivity beds were not present, thus changing the apparent resistivity of the low-resistivity bed. The shoulder bed effect is the result of deviation from the basic convolution model that is used in inversion. Measurements such as acoustic measurements and nuclear measurements have shoulder bed effects that can be ignored. In another embodiment of the invention, steps 169 and 171 of FIG. 6 are omitted.

We next discuss certain operations that may be used in conjunction with any of the embodiments of the invention discussed above. These relate to methods of improving the accuracy of the results obtained by the inversion and speeding-up of the computations.

The first of these operations relates to the generation of an initial 1-D model. Estimation of initial model parameters is accomplished using real-time point-by-point 1D radial inversion of array logs. The modeling engine of this inversion uses the Radial Look-Up Tables (LUTR) or Neural-Nets (NN).

The next of these operations relates to generation of an initial 2-D or 3D model and optimization of formation boundary positions. The initial 1-D model is based on the initial 1-D model with no radial variation. To reduce the number of inversion parameters, we can optimize the layer thicknesses instead of the boundary positions. This can be done, for example, by using a four-layer window sliding downward. Different window length can be used in this process. Each processing window consists of two central layers and the shoulders above and below the processing window. It is optional to include layer resistivities in this optimization process. Therefore, when performing the inversion step for a single window, we optimize only the central layer thicknesses two in this case.

It should be noted that when performing the forward modeling at each processing step, both the two central layers and shoulders are included in the model. This allows us to take into account the approximate shoulder-bed effect while optimizing the layer boundary positions. At each step, we slide the processing window downward by only one layer and reprocess the data. In the general case, when both the borehole and formation parameters are used, our basic interpretation model can be described by seven parameters and the corresponding 1D Look-Up Tables of vertical tool responses (LUTV) can be calculated. These tables enable the optimization of formation boundary positions to be performed in real-time. Combining the results of the two previous steps, which were obtained using the LUTR and LUTV-based real-time 1D inversion runs, we can now generate an initial model for the Localized Rapid Inversion method discussed next.

Those versed in the art would recognize that due to the large number of parameters, it is not feasible to calculate reliable look-up tables for a multi-layer 2D/3D formation model. However, the real-time requirements for 2D inversion can be achieved with a method we call Localized Rapid Inversion (LRI), which makes use of a short-window technique described above.

Each downward sliding ‘short window’ used for rapid inversion consists of three central layers and the shoulders above and below the processing window. The use of three central layers is not to be construed as a limitation to the invention. The shoulders can consist of several layers. When performing the inversion step for a single window, we optimize model parameters of the three central layers only. It is to be noted that different window length can be used in this process. When performing the forward modeling at each processing step, both the three central layers and shoulders are included in the model. This allows us to take into account the shoulder-bed effect while determining the formation properties. At each step, we slide the processing window down by one layer and reprocess the data; so if we use for example a three-layer inversion window, there is always a two-layer overlap with the inversion window of the previous step. This approach provides stable interpretation results, and it should be noted that it can be run from top to bottom or from bottom to top of the processed interval, which can accelerate LRI up to two-fold.

The parameters of interest that may be determined using the method of the present invention may include but not limited to layer thickness, a layer resistivity, a length of an invaded zone, a resistivity of an invaded zone, a length of an annular zone in the earth formation, and a relative dip angle between the layers and the borehole.

The processing of the measurements made in wireline applications may be done by a surface processor, by a downhole processor, or at a remote location. The data acquisition may be controlled at least in part by the downhole electronics. Implicit in the control and processing of the data is the use of a computer program on a suitable machine readable medium that enables the processors to perform the control and processing. The machine readable medium may include ROMs, EPROMs, EEPROMs, Flash Memories and Optical disks. The term processor is intended to include devices such as a field programmable gate array (FPGA). The results of the processing may be output to a suitable medium and/or may be used for geosteering, making operational decisions relating to reservoir development including, well completion and drilling of additional wells.

The present invention has been discussed above with respect to measurements made by a galvanic logging tool conveyed on a wireline. This is not intended to be a limitation and the method is equally applicable to other measurements including multiarry induction measurements, multicomponent induction measurements, acoustic measurements and nuclear measurements, and to measurements made with tool conveyed on a measurement- and logging-while-drilling (MWD/LWD) assembly conveyed on a drill string or on coiled tubing. The method is applicable for measurements made in vertical or deviated (including horizontal) wells and may further include estimation of relative dip as part of the model.

While the foregoing disclosure is directed to specific embodiments of the invention, various modifications will be apparent to those skilled in the art. It is intended that all variations within the scope of the appended claims be embraced by the foregoing disclosure.

What is claimed is:

1. A method of evaluating an earth formation, the method comprising:
(a) defining a plurality of layers of the earth formation;
(b) making measurements with a logging tool in a borehole in the earth formation over a depth interval corresponding to the plurality of layers;
(c) defining a first window consisting of a first subset of the plurality of layers;
(d) estimating from the measurements over the first window a parameter of interest of the earth formation for each of the first subset of plurality of layers;
(e) defining a second window consisting of a second subset of the plurality of layers, the second subset having at least one layer in common with the first subset;
(d) estimating from the measurements made over the second window the parameter of interest of the earth formation for each of the second subset of the plurality of layers.

2. The method of claim 1 wherein the parameter of interest is selected from the group consisting of (i) a thickness of a layer in the earth formation, (ii) a resistivity of a layer in the earth formation, (iii) a resistivity of an invaded zone in the earth formation, (iv) a length of an invaded zone in the earth formation, (v) a length of an annular zone in the earth formation, and (vi) a relative dip angle of a layer in the earth formation.

3. The method of claim 1 wherein the measurements are selected from the group consisting of (i) galvanic resistivity measurements, and (ii) induction resistivity measurements.

4. The method of claim 1 wherein estimating the parameter of interest further comprises using at least one of (i) a radial look-up table, and (ii) a vertical look-up table.

5. The method of claim 1 wherein the second window is below the first window.

6. The method of claim 1 wherein the second window is above the first window.

7. The method of claim 1 wherein estimating the parameter of interest further comprises estimating a property of a shoulder layer.

8. The method of claim 1 wherein estimating the parameter of interest further comprises using an initial 1-D model.

9. The method of claim 8 wherein estimating the parameter of interest further comprises defining an initial 2-D model derived from the initial 1-D model.

10. An apparatus for evaluating an earth formation, the apparatus comprising:
(a) a logging tool conveyed in a borehole in the earth formation configured to make measurements over a depth interval corresponding to a plurality of layers;
(b) a processor configured to:
(A) define a first window consisting of a first subset of the plurality of layers;
(B) estimate from measurements made over the first window a parameter of interest of the earth formation for each of the first subset of the plurality of layers;
(C) define a second window consisting of a second subset of the plurality of layers, the second subset having at least one layer in common with the first subset; and
(D) estimate from the measurements over the second window the parameter of interest for each of the second subset of the plurality of layers.

11. The apparatus of claim 10 wherein the processor is further configured to estimate at least one of (i) a thickness of a layer in the earth formation, (ii) a resistivity of a layer in the earth formation, (iii) a resistivity of an invaded zone in the earth formation, (iv) a length of an invaded zone in the earth formation, (v) a length of an annular zone in the earth formation, and (vi) a relative dip angle of a layer in the earth formation.

12. The apparatus of claim 11 further comprising at least one of (i) an induction resistivity instrument, and (ii) a galvanic resistivity instrument.

13. The apparatus of claim 10 wherein the processor is configured to estimate the parameter of interest using at least one of (i) a radial look-up table, and (ii) a vertical look-up table.

14. The apparatus of claim 10 wherein the second window is below the first window.

15. The apparatus of claim 10 wherein the second window is above the first window.

16. The apparatus of claim 10 wherein the processor is configured to estimate the parameter of interest by further estimating a property of a shoulder layer.

17. The apparatus of claim 10 wherein the processor is further configured to estimate the parameter of interest by using an initial 1-D model.

18. The apparatus of claim 17 wherein the processor is further configured to estimate the parameter of interest by defining an initial 2-D model derived from the initial 1-D model.

19. A computer-readable medium used for use with a logging conveyed in a borehole in an earth formation, the medium comprising instructions which enable a processor to:
(A) define a first window consisting of a first subset of the plurality of layers;
(B) estimate from measurements made over the first window a parameter of interest of the earth formation for each of the first subset of the plurality of layers;
(C) define a second window consisting of a second subset of the plurality of layers, the second subset having at least one layer in common with the first subset; and
(D) estimate from the measurements over the second window the parameter of interest for each of the second subset of the plurality of layers.

20. The medium of claim 29 further comprising at least one of (i) a ROM, (ii) an EPROM, (iii) an EEPROM, (iv) a flash memory, and (v) an optical disk.
